(19) United States
(12) Patent Application Publication
(10) Pub. No.: US 2009/0051664 A1
(43) Pub. Date: Feb. 26, 2009

(54) METHOD OF SETTING AUDIO SIGNAL AND AUDIO APPARATUS TO USE THE SAME

(75) Inventor: Yoon-hark OH, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/021,628

(22) Filed: Jan. 29, 2008

(30) Foreign Application Priority Data
Aug. 21, 2007 (KR) 2007-84201

(51) Int. Cl. G06F 3/041

(52) U.S. Cl. 345/173

(57) ABSTRACT

A method of setting an audio signal, and an audio apparatus using the same. The audio apparatus includes a display to display a plurality of audio signal information, an input to receive a touch trace formed on the display as a command, a controller to change the audio signal information based on the touch trace, and a signal processor to process an audio signal according to the changed audio signal information, wherein if an area displaying one of the plurality of audio signal information displayed on the display is touched, the controller highlights the touched audio signal information. A plurality of information are changed using one touch trace to improve a user's convenience.

### CROSS-REFERENCE TO RELATED APPLICATIONS

This application claims priority under 35 U.S.C. § 119 (a) from Korean Patent Application No. 10-2007-0084201, filed on Aug. 21, 2007, in the Korean Intellectual Property Office, the disclosure of which is incorporated herein by reference in its entirety.

### BACKGROUND OF THE INVENTION

1. Field of the Invention

The present general inventive concept relates to an audio apparatus and a control method thereof. More particularly, the present general inventive concept relates to a method of setting audio signal information of an audio apparatus, and an audio apparatus using the same.

2. Description of the Related Art

A general audio apparatus, such as a MPEG layer 3 (MP3) player, retrieves and decodes an MP3 audio signal stored in a storage unit such as a flash memory or miniaturized hard disc drive (HDD) to replay an audio signal having a high sound quality.

If an MP3 player performs an operation in response to a user's request, a current operation state is displayed through a display panel such as a liquid crystal display (LCD). Accordingly, a user knows the current operation state of the MP3 player.

The MP3 player outputs through the display panel various file information of currently replayed MP3 audio data or equalizer information representing a frequency response of a currently replayed audio signal. As a result, the user can easily check the information of the currently replayed audio file.

A recently developed MP3 player has a touch screen panel providing both display function and touch pad function instead of the display panel. The user checks various information displayed through the touch screen panel, and concurrently can change the information by touching a key representing a desired operation.

The equalizer information corresponding to an audio signal includes a plurality of frequency bandwidths and a level set to each of the frequency bandwidths. If a user uses a touch screen panel to change the equalizer information including the plurality of frequency bandwidths, the user has to repetitively use touch keys to select a frequency band, change a level of the frequency band, select other frequency band, and change a level of the frequency band. Accordingly, when the user changes information consisting of a plurality of sub information such as equalizer information using a touch screen panel, improvement is hardly noticeable in comparison with the conventional hard key. Therefore, effectiveness of the touch screen panel is deteriorated.

### SUMMARY OF THE INVENTION

The present general inventive concept provides a method of changing an audio signal by changing information including a plurality of sub information using one touch trace, and an audio apparatus using the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an audio apparatus including a display to display a plurality of audio signal information, an input to receive a touch trace formed on the display as a user's command, a controller to change the audio signal information based on the touch trace, and a signal processor to process an audio signal according to the changed audio signal information, wherein if an area displaying one of the plurality of audio signal information displayed on the display is touched, the controller highlights the touched audio signal information.

If the touch trace is formed from an area displaying a first audio signal information to an area displaying a second audio signal information among the plurality of audio signal information, the controller may move the highlight from the first audio signal information to the second audio signal information.

The touched audio signal information may be highlighted by generating the size of the touched audio signal information to be lager than that of the other audio signal information.

The audio signal information may include a frequency band and a level set to the frequency band.

The display may display a band bar corresponding to the frequency band and a level point corresponding to the level, and if a certain area is touched among areas displaying the band bar, the controller may move the level point to the certain area.

If a touch of the area displaying the band bar is completed, the controller may determine the level corresponding to the level point as a level of the frequency band corresponding to the band bar.

The apparatus may further include an equalizer filter generator to generate an equalizer filter based on the determined level.

If a predetermined time elapses after touching the display, the equalizer filter generator may generate the equalizer filter based on the level determined within the predetermined time.

If the touch is finished on the display, the equalizer filter generator may generate the equalizer filter based on the level determined before the touch is completed.

The foregoing and/or other aspects and utilities of the present general inventive concept may also be achieved by providing a method of controlling an audio apparatus, the method including displaying a plurality of audio signal information, receiving a touch trace formed on an area displaying the plurality of audio signal information as a user's command, changing the audio signal information based on the touch trace, and processing an audio signal according to the changed audio signal information, wherein if an area displaying one of the plurality of audio signal information displayed on the display is touched, the displaying highlights the touched audio signal information.

If the touch trace is formed from an area displaying a first audio signal information to an area displaying a second audio signal information among the plurality of audio signal information, the displaying may move the highlight from the first audio signal information to the second audio signal information.

The audio signal information may include a frequency band and a level set to the frequency band.

The displaying may display a band bar corresponding to the frequency band and a level point corresponding to the level, and if a certain area is touched among areas displaying the band bar, the displaying may move the level point to the certain area.

If a touch of the area displaying the band bar is completed, the changing may determine the level corresponding to the level point as a level of the frequency band corresponding to the band bar, so that the audio signal is changed.

The method may further include generating an equalizer filter based on the determined level.

If a predetermined time elapses after touching an area displaying the band bar, the generating may generate the equalizer filter based on the level determined within the predetermined time.

If the touch of the area displaying the band bar is finished, the generating generator may generate the equalizer filter based on the level determined before the touch is completed.

The foregoing and/or other aspects and utilities of the present general inventive concept may also be achieved by providing a computer-readable medium to contain computer-readable codes as a program to execute a method of an audio apparatus, the method including displaying a plurality of audio signal information, receiving a touch trace formed on an area displaying the plurality of audio signal information as a user's command, changing at least one of the plurality of the audio signal information based on the touch trace, and processing an audio signal according to the changed audio signal information, wherein if an area displaying one of the plurality of audio signal information displayed on the display is touched, the displaying highlights the touched audio signal information.

The foregoing and/or other aspects and utilities of the present general inventive concept may also be achieved by providing an audio apparatus including a display unit to display a plurality of audio signal information and to receive a touch trace to correspond to at least one of the plurality of audio signal information, and a controller to change the at least one of the plurality of audio signal information according to the received touch tracer.

The audio apparatus may further include a signal processor to process an audio signal according to the changed audio signal information.

The touch tracer may include a touch point moving from a first area to a second area within the displayed audio signal information.

The displayed audio signal information may include an equalizer to represent a characteristic of an audio signal, and the touch tracer comprises a highlighted portion of the equalizer to change the characteristic of an audio signal.

The foregoing and/or other aspects and utilities of the present general inventive concept may also be achieved by providing an audio apparatus including a signal process to process an audio signal to be replayed, a display to display a plurality of audio signal information of the audio signal on a screen and to receive a touch trace to correspond to at least one of the plurality of audio signal information through the screen, and a controller to change the at least one of the plurality of audio signal information according to the received touch tracer, and to control the signal process to process the audio signal according to the changed audio signal information.

The foregoing and/or other aspects and utilities of the present general inventive concept may also be achieved by providing a method of an audio apparatus, the method including displaying a plurality of audio signal information on a screen of a display and to receive a touch trace to correspond to at least one of the plurality of audio signal information through the screen of the display, and changing the at least one of the plurality of audio signal information according to the received touch tracer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an audio apparatus according to an exemplary embodiment of the present general inventive concept;

FIG. 2 is a flowchart illustrating a process of changing equalizer information according to an exemplary embodiment of the present general inventive concept;

FIGS. 3A to 3G are views illustrating the process of changing equalizer information.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

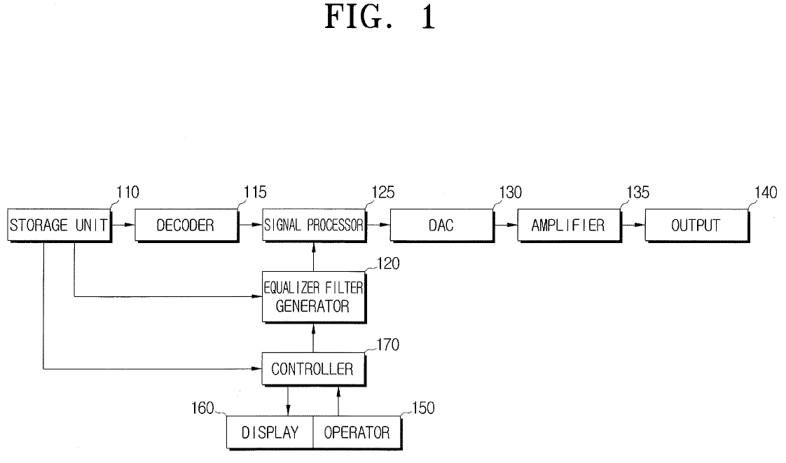

FIG. 1 is a block diagram illustrating an audio apparatus, such as an MPEG layer 3 (MP3) player as an example of the audio apparatus, according to an exemplary embodiment of the present general inventive concept. Referring to FIG. 1, the MP3 player may include a storage unit 110, a decoder 115, a signal processor 125, a digital-to-analog converter (DAC) 130, an output unit 140, an equalizer filter generator 120, an operator 150, a display 160, and a controller 170.

The storage unit 110 may store an audio signal and audio signal information. The audio signal information may be information on the audio signal, such as a title, composer, and lyrics of a music file, and equalizer information corresponding to the audio signal. The audio signal may be a plurality of audio signals, and the audio signal information may be a plurality of information to corresponding to the respect audio signals. The equalizer information relates to a frequency response which corresponds to the audio signal when the audio signal is replayed. The equalizer information is defined as a plurality of frequency bands and a level of each of the frequency bands. The equalizer information may be preset with respect to each file of the audio signals, and changed by a user. The audio signal may be a compressed audio signal.

The decoder 115 decompresses the audio signal stored at the storage unit 110, and transfers the decompressed signal to the signal processor 125. The equalizer filter generator 120 generates an equalizer filter using the equalizer information stored at the storage unit 110, and transfers the generated equalizer filter to the signal processor 125.

The equalizer filter generator 120 may receive from the controller 170 a portion or all of the equalizer information required to generate the equalizer filter. If the equalizer filter generator 120 receives all of the equalizer information from the controller 170, the equalizer filter generator 120 may generate an equalizer filter using the equalizer information received from the controller 170. On the other hand, if the equalizer filter generator 120 receives a part of the equalizer information from the controller 170, the equalizer filter generator 120 may generate an equalizer filter using a portion of the equalizer information received from the controller 170 and a remaining portion of the equalizer information stored at the storage unit 110.

The signal processor 125 processes the audio signal received from the decoder 115 into a replayable audio signal. The signal processor 125 uses an equalizer filter received from the equalizer filter generator 120 to process the audio signal into a replayable audio signal.

The DAC 130 converts the processed audio signal into an analog audio signal. The analog audio signal is amplified through an amplifier 135, and the amplified signal is output to an outside thereof through the output unit 140 such as a speaker or headphone. The output unit 140 may be connectable to the amplifier 135 through a communication line.

The operator 150 receives a command. The command may be a user command. The display 160 displays menu information or audio signal information of the MP3 player. The MP3 player may be implemented using a touch screen panel having both functions of the display 160 and the operator 150. Accordingly, a user touches an area displaying a portion of the audio signal information while viewing audio signal information displayed on the touch screen panel to input the command.

The controller 170 controls the overall operations of the MP3 player. That is, the controller 170 determines the command input through the operator 150. The controller 170 controls function blocks of the MP3 player to replay an audio signal, generates equalizer information of a type of the audio signal information, and displays the generated equalizer information on the display 160. If a command to change the equalizer information is input, the controller 170 controls the equalizer filter generator 120 to generate the equalizer filter according to the changed equalizer information.

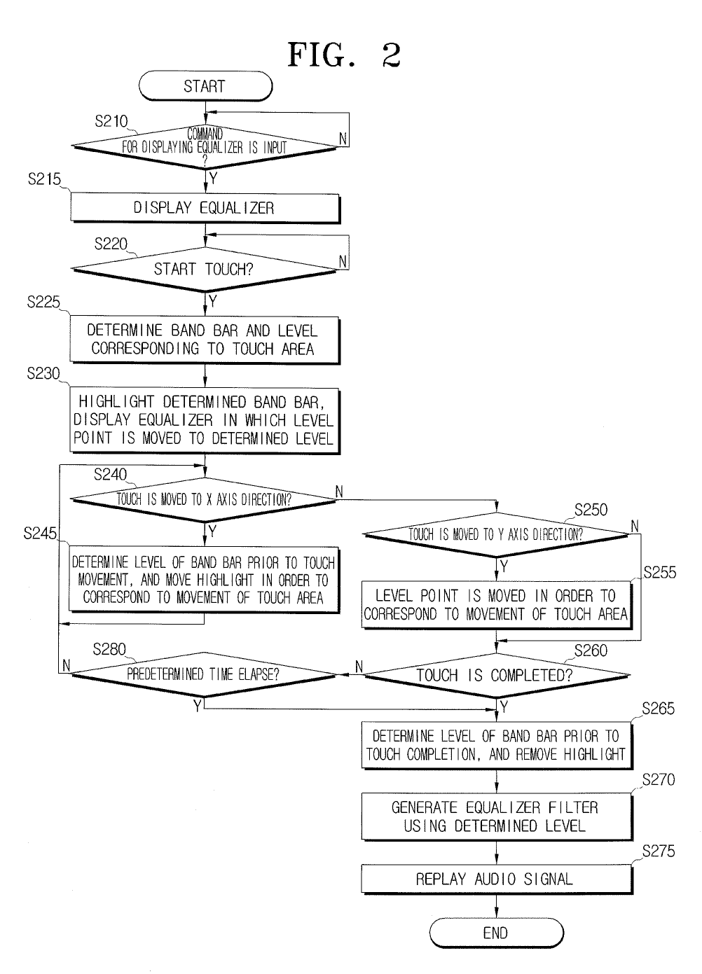

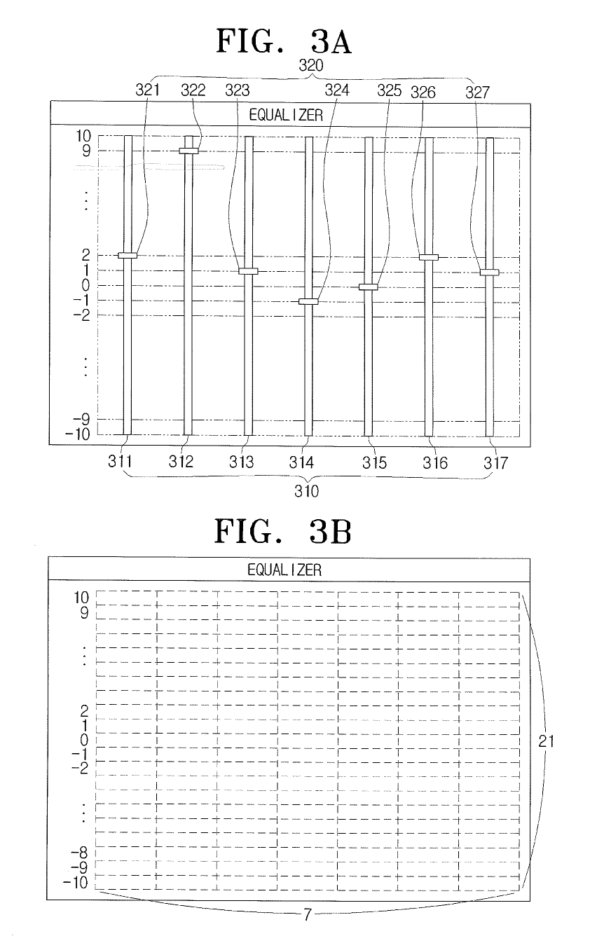

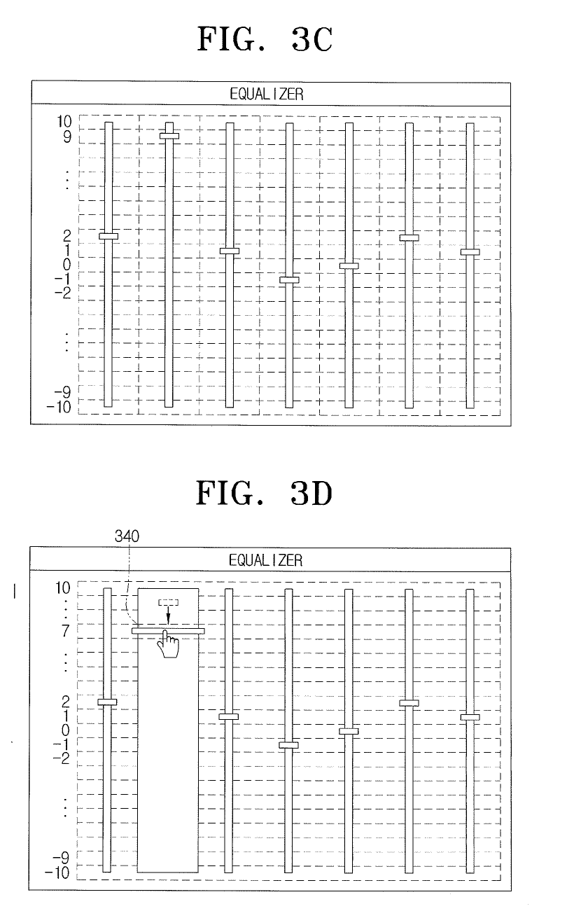

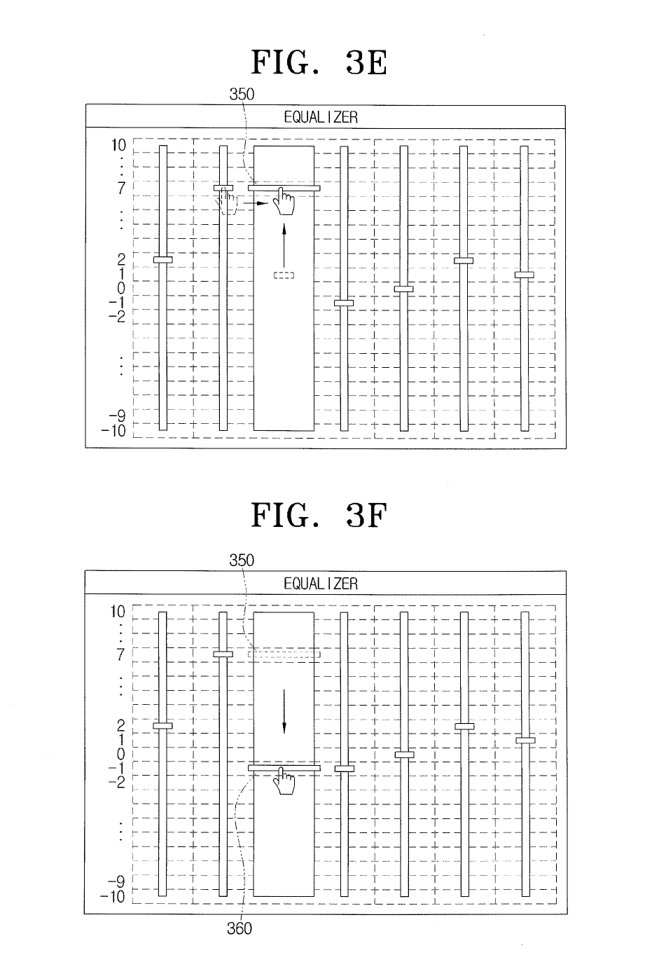

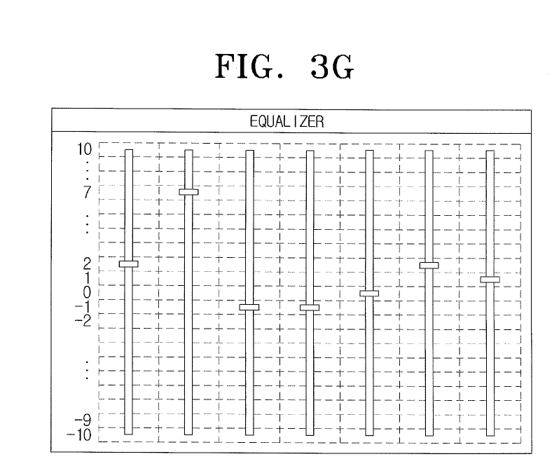

FIG. 2 is a flowchart illustrating a process of changing equalizer information according to an exemplary embodiment of the present general inventive concept. FIGS. 3A to 3G are views illustrating the process of changing equalizer information.

Referring to FIGS. 1 and 2, in operation S210-Y, if a command for displaying an equalizer is input, in operation S215, the controller 170 retrieves from the storage unit 110 equalizer information corresponding to a currently replayed audio signal or an audio signal to be replayed, generates an equalizer using the retrieved equalizer information, and displays the generated equalizer on the display 160 in operation S215. A frequency corresponding to a general audio apparatus is in a range of 16 Hz to 20 kHz, the number of frequency bands used in the equalizer information ranges from 5 to 30, and a level set to each of the frequency bands ranges from −12 dB to +12 dB.

The equalization information having seven frequency bands is explained as an example for convenient explanation in the exemplary embodiment of the present general inventive concept. The level set to the each frequency band is in a range of −10 dB to +10 dB, and the level changes by a unit of 1 dB.

FIG. 3A is a view illustrating an equalizer according to an exemplary embodiment of the present general invention concept. Referring to FIG. 3A, the equalizer includes band bars corresponding to frequency bands, and level points corresponding to levels set to each frequency band. A user touches at least one of the band bars to select the frequency band, and moves the corresponding level point to change the level.

If a command for displaying the equalizer is input, the controller 170 retrieves the equalizer information of an audio signal currently replayed or to be replayed from the storage unit 110, that is, retrieves the first to seventh frequency bands and the levels set to each frequency band. The controller generates an equalizer including band bars 310 corresponding to frequency bands and level points 320 corresponding to levels, and displays the generated equalizer on the display 160. The equalizer is displayed on a screen of the display 160 as illustrated in FIG. 3A. The display 160 may be a touch screen panel.

In operation S220, the controller 170 determines whether a command indicating a touch point (area) as a touch start is input in an area displaying the equalizer. Referring to FIG. 3B, the area displaying the equalizer is divided into a plurality of touch areas. Each of the divided touch areas transfers different touch results to the controller 170, and the controller 170 determines that the command for changing the level of a certain frequency band is input based on the touch results. As the exemplary embodiment of the present general inventive concept employs seven frequency bands, the area displaying the equalizer may be divided into seven touch areas in a width direction. As the levels set for the frequency band range from 10 to −10, the area displaying the equalizer, which will be referred herein as an equalizer display area, may be divided into 21 touch areas in a length direction.

The equalizer display area may be divided into a plurality of touch areas which are arranged in a matrix (a_{i,j}) with 7 columns and 21 rows as illustrated in FIG. 3B. FIG. 3C is a view illustrating an equalizer and a touch area. One column corresponds to one band bar, one touch bar consists of 21 touch areas, and one touch area includes one level point.

In operation S220-Y, if it is determined that a command to indicate the touch start is input by a user, the controller 170 determines the band bar and level corresponding to the touch area in operation S225. For example, if the user touches an area (a_{2,7}), the operator 150 transfers the touch results to the controller 170. The controller 170 determines that level 7 of the second band bar is touched based on the touch result that the area (a_{2,7}) is touched.

In operation S230, the controller 170 highlights the determined band bar, generates an equalizer in which a level point of the determined band bar moves to a determined level point corresponding to another touch point (area), for example, a touch end, and displays the generated equalizer on the display 160. That is, the controller 170 highlights the second band bar, generates the equalizer in which the level point in the second band bar moves to level 7, and displays the generated equalizer on the display 160. That the band bar is highlighted indicates that a size of the band bar is generated to be lager than that of the other band bars. When the band bar is highlighted, the corresponding level point is concurrently highlighted together.

FIG. 3D is a view illustrating an equalizer when a touch area (a_{2,7}) 340 is touched as the touch end. A width of the second band bar may correspond to a size of the touch area of the second column. Because the band bar touched by the user is highlighted, the user can be informed of a frequency band to be changed, and the user can more easily recognize the equalizer information.

In operation S240, the controller 170 determines whether a command indicating a touch movement (movement of the touch point or area) to an X axis direction, in which the area bars are arranged, is input by a user. The user may move to a touch area (a_{3,7}) 350, after touching the touch area (a_{2,7}) 340. The controller 170 determines that the touch movement occurs in the X axis direction.

In operation S245, the controller 170 determines the level of the band bar prior to the touch movement, transfers the level to the equalizer filter generator 120, and moves the highlight in order to correspond to the movement of the touch area. That is, if the user touches the touch area (a_{2,7}) 340 and moves to the touch area (a_{3,7}) 350, the controller 170 determines the level of the second frequency band corresponding to the second band bar to be 7 dB, and transfers the determined result to the equalizer filter generator 120. The controller 170 reduces the size of the second band bar to return to the original size formed before the band bar was highlighted. The controller 170 generates the third band bar to be lager than that of other band bars, generates an equalizer in which the level point is moved to level 7, and displays the generated equalizer on the display 160. That the size of the second band bar is reduced to that of the other band bars, and that the size of the third band bar is increased to be lager than that of the other band bars, indicates that the highlight moves from the second band bar to the third band bar.

FIG. 3E is a view illustrating an equalizer, in which a user moves a touch area from the touch area (a_{2,7}) 340 to the touch area (a_{3,7}) 350. As the user moves from the touch area (a_{2,7}) 340 to the touch area (a_{3,7}) 350, the size of the second band bar is reduced, the size of the third band bar is increased, and the level point of the third band bar moves from level 9 to level 7.

In operation S250, the controller 170 determines whether a command for the touch movement to a Y axis direction, in which the level bar is disposed, is input by the user. The user may drag the touch point (area) to move the level point while touching the equalizer in order to change the level of the touched band bar. For example, the user moves the touch from the touch area (a_{2,7}) 340 to the touch area (a_{3,7}) 350. In other word, the touch area only moves from the touch area (a_{3,7}) 350 along the Y axis direction, that is, to a touch area (a_{3,-1}) 360, without moving in the X axis direction. Accordingly, the controller 170 determines that the touch area moves to the Y axis direction.

In operation S250-Y, if it is determined that the touch is moved to the Y axis direction, the controller 170 generates an equalizer, in which the level point is moved in order to correspond to the movement of the touch area, and displays the generated equalizer on the display 160 in operation S255. That is, if the touch movement is made from the touch area (a_{3,7}) 350 to the touch area (a_{3,-1}) 360, the controller 170 moves the level point of the third band bar from level 7 to level −1. As the touch movement is continuously made, the touch has to pass the touch areas (a_{6,3}) through (a_{3,-1}) to move from the touch area (a_{3,7}) 350 to the touch area (a_{3,-1}) 360. FIG. 3F is a view illustrating an equalizer when a touch trace is formed from the touch area (a_{3,7}) 350 to the touch area (a_{3,-1}) 360. The touch trace may include at least one of an arrow, a pointer corresponding to the level point, and the highlighted area.

The user changes the levels of the band bars using the touch trace while viewing the band bars displayed on the touch screen, thereby the user may simply change the levels set to the plurality of frequency bands.

For example, if the user desires to change the levels of the second to sixth frequency bands, the user touches the second band bar corresponding to the second frequency band, moves the level point to the desired level, also touches the third band, and moves the level point of the third band bar to a desired level. As touching the touch areas of the second to sixth band bars, the levels of the plurality of frequency bands may be changed with the formation of the touch trace on the touch screen panel.

Whenever the touch movement is made in the X axis direction, the controller 170 transfers the level of the frequency band corresponding to the previous touch area to the equalizer filter generator 120. That is, if the touch point (area) is moved from the touch area (a_{2,7}) to the touch area (a_{3,7}), the controller 170 determines the level of the second frequency band to be 7 dB, and transfers the determined level to the equalizer filter generator 120. If the touch is moved from the touch area (a_{3,-1}) to the touch area (a_{4,-1}), the controller 170 determines the level of the third frequency band to be −1 dB, and transfers the determined level to the equalizer filter generator 120. As doing so, if the user draws the touch trace from the second to sixth band bars, the levels of the second to sixth frequency bands are determined.

In operation S260, the controller 170 determines that the touch is completed. If it is determined that setting up the equalizer is completed, the user releases a user finger from the touch screen panel, and thereby the touch process is finished. The controller 170 does not receive any touch result from the operator 150, so determines that the touch is finished.

In operation S260-Y, if it is determined that the touch process, that is, a changing process, is completed, in operation S265, the controller 170 determines the level of the band bar prior to the touch completion, transfers the determined level to the equalizer filter generator 120, and removes the highlight from the equalizer. For example, if the user moves the level point of the sixth band bar to level 7, and completes the touch, the controller 170 determines the level of the sixth frequency band to be 7 dB, and transfers the determined level to the equalizer filter generator 120. The controller 170 generates the equalizer without the highlight, and displays the generated equalizer on the display 160. FIG. 3G is a view illustrating an equalizer when the levels of the second to sixth frequency bands are changed.

In operation S270, the equalizer filter generator 120 generates an equalizer filter having the level of the determined frequency band, and transfers the generated equalizer filter to the signal processor 125. If a command to replay an audio signal is input, the equalizer filter generator 120 retrieves the levels of the first to seventh frequency bands from the storage unit 110, generates an equalizer filter, and transfers the generated equalizer filter to the signal processor 125. If the equalizer filter generator 120 receives the levels of the second to sixth frequency bands from the controller 170 while the audio signal is replayed, and the equalizer filter generator 120 renews the levels of the second to sixth frequency bands, generates a new equalizer filter using the renewed levels of the second to sixth frequency bands and the existing levels of the first to seventh frequency bands, and transfers the generated equalizer filter to the signal processor 125.

In operation S275, an audio apparatus replays the audio signal using the newly generated equalizer filter. That is, the signal processor 125 processes the audio signal transferred from the decoder 115 using the new equalizer filter. The processed audio signal is converted into an analog audio signal through the DAC 130, the converted audio signal is amplified through the amplifier 135, and the amplified signal is output through a speaker or headphone. As a result, the audio signal is replayed using the newly generated equalizer filter. The user can listen to the audio signal replayed based on the equalizer information that he changed.

In operation S260-N, if it is determined that the touch process is not completed, in operation S280, the controller 170 determines that a predetermined time is elapsed. The user may move the touch in an X axis direction or a Y axis direction for the predetermined time. When the touch is moved in the X axis direction, operation S245 is reiterated, and when the touch is moved in the Y axis direction, operation S255 is reiterated. When the touch is moved both directions of X and Y axes, operations S245 and S255 are reiterated of course.

In operation S280-Y, if the predetermined time elapses without having a touch movement, the audio apparatus performs the operations S265 to S275 in the same manner as the touch is finished.

If a predetermined time elapses after a touch is moved, an equalizer filter with respect to changed equalizer information is generated in the exemplary embodiment of the present general inventive concept. However, this should not be considered limiting. If a predetermined time passes after a user touches a touch screen panel, an equalizer filter may be generated based on equalizer information changed within the predetermined time, and the equalizer filter is generated whenever the equalizer information is changed, and the audio signal may be processed using the generated equalizer filter. It is possible that the screen of the display unit can be changed from the equalizer to a predetermined menu screen after a process of changing the audio information is completed.

When a band bar is highlighted, the highlighted band bar is enlarged to be lager than the other band bars in the exemplary embodiment of the present general inventive concept. However, this should not be considered limiting. Alternatively, the color of the highlighted band bar may be changed differently from the other band bars. The level point is represented in a square shape in the exemplary embodiment of the present general inventive concept, but the level point may be represented with boundary lines between colors. For example, if the level point is in level 7, the color of the band bars of levels −10 to 7 is displayed differently from the color of the band bars of level 7 to 10 to classify the level point.

While the size of the highlighted band bar is identical to that of the selected touch area in the exemplary embodiment of the present general inventive concept, this should not be considered limiting. For example, if the band bar is highlighted by displaying the band bar in a different color from that of the other band bars, the size of the highlighted band bar may not need identical to the size of the selected touch area.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, a plurality of information are changed by forming only one touch trace according to the exemplary embodiment of the present general inventive concept. Accordingly, a user's convenience is improved.

Because the information is highlighted among the plurality of information, a user knows what information he is changing. Accordingly, the user can change the information more accurately. If the predetermined time elapses even before the touch is completed, the audio signal is processed according to the changed information. Therefore, the user can check the audio signal replayed according to the changed information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio apparatus comprising:
a display to display a plurality of audio signal information;
an input to receive a touch trace formed on the display as a command;
a controller to change at least one of the plurality of the audio signal information based on the touch trace; and
a signal processor to process an audio signal according to the changed audio signal information,
wherein if an area displaying one of the plurality of audio signal information displayed on the display is touched, the controller highlights the touched audio signal information.

2. The apparatus of claim 1, wherein if the touch trace is formed from a first area displaying first audio signal information to a second area displaying second audio signal information among the plurality of audio signal information, the controller moves the highlight from the first audio signal information to the second audio signal information.

3. The apparatus of claim 1, wherein the controller highlights the touched audio signal information by generating a size of the touched audio signal information to be lager than that of the other audio signal information.

4. The apparatus of claim 1, wherein the audio signal information comprises a frequency band and a level set to the frequency band.

5. The apparatus of claim 4, wherein:
the display displays a band bar corresponding to the frequency band and a level point corresponding to the level; and
if another area is touched among areas, the controller moves the level point to the another area.

6. The apparatus of claim 5, wherein if a touch of the area displaying the band bar is completed, the controller determines the level corresponding to the level point as a level of the frequency band corresponding to the band bar.

7. The apparatus of claim 6, further comprising:
an equalizer filter generator to generate an equalizer filter based on the determined level.

8. The apparatus of claim 7, wherein if a predetermined time elapses after touching the display, the equalizer filter generator generates the equalizer filter based on the level determined within the predetermined time.

9. The apparatus of claim 7, wherein if the touch is finished on the display, the equalizer filter generator generates the equalizer filter based on the level determined before the touch is completed.

10. A method of controlling an audio apparatus comprising:
displaying a plurality of audio signal information;
receiving a touch trace formed on an area displaying the plurality of audio signal information as a user's command;
changing at least one of the plurality of the audio signal information based on the touch trace; and
processing an audio signal according to the changed audio signal information,
wherein if an area displaying one of the plurality of audio signal information displayed on the display is touched, the displaying highlights the touched audio signal information.

11. The method of claim 10, wherein if the touch trace is formed from a first area displaying first audio signal information to a second area displaying second audio signal information among the plurality of audio signal information, the displaying moves the highlight from the first audio signal information to the second audio signal information.

12. The method of claim 10, wherein the audio signal information comprises a frequency band and a level set to the frequency band.

13. The method of claim 12, wherein:
the displaying of the plurality of audio signal information comprises displaying a band bar corresponding to the frequency band and a level point corresponding to the level; and
if another area is touched among the areas, the displaying of the plurality of audio signal information comprises moving the level point to the another area.

14. The method of claim 13, wherein if a touch of the area displaying the band bar is completed, the changing determines the level corresponding to the level point as a level of the frequency band corresponding to the band bar, so that the audio signal is changed.

15. The method of claim 14, further comprising:
generating an equalizer filter based on the determined level.

16. The method of claim 14, wherein if a predetermined time elapses after touching an area displaying the band bar, the generating generates the equalizer filter based on the level determined within the predetermined time.

17. The method of claim 14, wherein if the touch of the area displaying the band bar is finished, the generating generator generates the equalizer filter based on the level determined before the touch is completed.

18. A computer-readable medium to contain computer-readable codes as a program to execute a method of an audio apparatus, the method comprising:
displaying a plurality of audio signal information;
receiving a touch trace formed on an area displaying the plurality of audio signal information as a user's command;
changing at least one of the plurality of the audio signal information based on the touch trace; and
processing an audio signal according to the changed audio signal information,
wherein if an area displaying one of the plurality of audio signal information displayed on the display is touched, the displaying highlights the touched audio signal information

19. An audio apparatus comprising:
a display unit to display a plurality of audio signal information and to receive a touch trace to correspond to at least one of the plurality of audio signal information; and
a controller to change the at least one of the plurality of audio signal information according to the received touch tracer.

20. The audio apparatus of claim 19, further comprising:
a signal processor to process an audio signal according to the changed audio signal information.

21. The audio apparatus of claim 19, wherein the touch tracer comprises a touch point moving from a first area to a second area within the displayed audio signal information.

22. The audio apparatus of claim 19, wherein:
the displayed audio signal information comprises an equalizer to represent a characteristic of an audio signal; and
the touch tracer comprises a highlighted portion of the equalizer to change the characteristic of an audio signal.
